(19) United States
(12) Patent Application Publication
(10) Pub. No.: US 2016/0135367 A1
(43) Pub. Date: May 19, 2016

(54) System for Cooling the Inside of the Filament Enclosure on a Vegetation Trimmer

(71) Applicant: James Doane, Friendswood, TX (US)

(72) Inventor: James Doane, Friendswood, TX (US)

(21) Appl. No.: 14/542,570

(22) Filed: Nov. 15, 2014

(51) Int. Cl. A01D 34/416

(52) U.S. Cl. CPC A01D 34/416

(57) ABSTRACT

A vegetation trimmer with a filament enclosure has cutting filament stored inside the filament enclosure. The free end of the cutting filament extends through a portal in the filament enclosure into the cutting plane. The filament enclosure is rotated at a high rate to allow the cutting filament to cut vegetation. Additional portals in the filament enclosure provide air circulation to the cutting filament stored inside the filament enclosure to prevent heating of the cutting filament during use.

### FIELD OF THE INVENTION

The present invention relates generally to line trimmers for cutting vegetation and, more particularly, relates to filament enclosures having cutting filament stored within and which are installed to shafts of trimmers.

### BACKGROUND OF THE INVENTION

Vegetation trimmers are in common use for cutting vegetation in areas that are difficult to reach such as along houses, sidewalks, or around trees and bushes. Bump feed trimmers are convenient because when the cutting filament wears down, the user simply taps the vegetation trimmer against a hard surface to feed more cutting filament into the cutting plane. Over time, the inside of the filament enclosure gets hot and eventually the cutting filament stored inside the filament enclosure welds together. This prevents the cutting filament from feeding into the cutting plane. The user then has to disassemble the filament enclosure to separate the welded together cutting filament.

Fixed line vegetation trimmers have been developed to address the problem of the cutting filament welding to itself. Fixed line trimmers do not have to feed cutting filament into the cutting plane during use, so it does not matter if the cutting filament gets welded together. The problem associated with this configuration is that the user has to stop more frequently to load new filament because he cannot feed more cutting filament into the cutting plane during use.

Easy feed vegetation trimmers have been developed to ease the process of adding cutting filament. The user inserts a length of filament through a portal in the hub, through the center of the spool, and through the portal in the hub directly opposite to the first portal in the hub. The user then simply twists the spool to wind the line onto the spool. While using an easy feed vegetation trimmer, the user taps the vegetation trimmer against a hard surface to feed more cutting filament into the cutting plane. The problem with this configuration is that it can become difficult to disassemble if the filament welds together.

Currently, portals are provided on the filament enclosure to allow the cutting filament to enter the cutting plane. Also, portals are provided so that manufacturing of the filament enclosure is possible. However, those skilled in the art have not realized that by making these portals larger, then sufficient air flow inside the filament enclosure can be achieved. The present invention addresses this issue by using a larger percentage of the surface area of the filament enclosure to provide portals to allow sufficient air flow inside the filament enclosure. This keeps the inside of the hub and spool assembly cool to prevent the filament from welding together.

### SUMMARY OF THE INVENTION

A vegetation trimmer with a filament enclosure is provided. At least one cutting filament extends radially outward into the cutting plane. The filament enclosure is rotated at a high rate to allow the cutting filament in the cutting plane to cut vegetation.

Preferably, portals are provided on the outside of the filament enclosure. The portals allow air to enter the inside of the filament enclosure to keep the inside of the filament enclosure cool.

Alternately, fins are provided on the outside of the filament enclosure to direct the air flow to inside the filament enclosure. An example is shown in FIG. 2. The fins extend the full length of the hub, and the fins are angled towards the direction of rotation of the filament enclosure to direct the air flow to inside the filament enclosure.

Those skilled in the art will appreciate that the present invention can be expanded such that the portals on the filament enclosure take different shapes and sizes. The present invention can also be expanded such that the portals are placed in different locations on the filament enclosure to create various patterns of air flow to the inside of the filament enclosure.

An object of this invention is to create a filament enclosure such that the cutting filament stored inside the filament enclosure does not weld together. The amount of time spent trimming an area of vegetation is significantly reduced because the user does not have to stop the vegetation trimmer to fix the cutting filament every time it welds together.

Another object of this invention is to create a filament enclosure such that the cutting filament stored inside the filament enclosure does not weaken due to being heated during normal operation. The amount of time spent trimming an area of vegetation is significantly reduced because the user does not have to stop the vegetation trimmer to fix the cutting filament every time it breaks due to being weakened by the high temperature on the inside of the filament enclosure.

The following US patents are relevant to the inner workings of string line trimmers: U.S. Pat. No. 4,047,299; U.S. Pat. No. 4,272,201; U.S. Pat. No. 4,524,515; U.S. Pat. No. 4,633,588; U.S. Pat. No. 4,656,739; U.S. Pat. No. 5,020,223; U.S. Pat. No. 5,339,526; U.S. Pat. No. 5,987,756; U.S. Pat. No. 6,094,823, U.S. Pat. No. 7,111,403, and U.S. Pat. No. 8,176,639.

### BRIEF DESCRIPTION OF THE DRAWINGS

FIG. 1 is a front view of the preferred embodiment;

FIG. 2 is a front view of the alternate embodiment.

### DETAILED DESCRIPTION OF THE PREFERRED EMBODIMENT

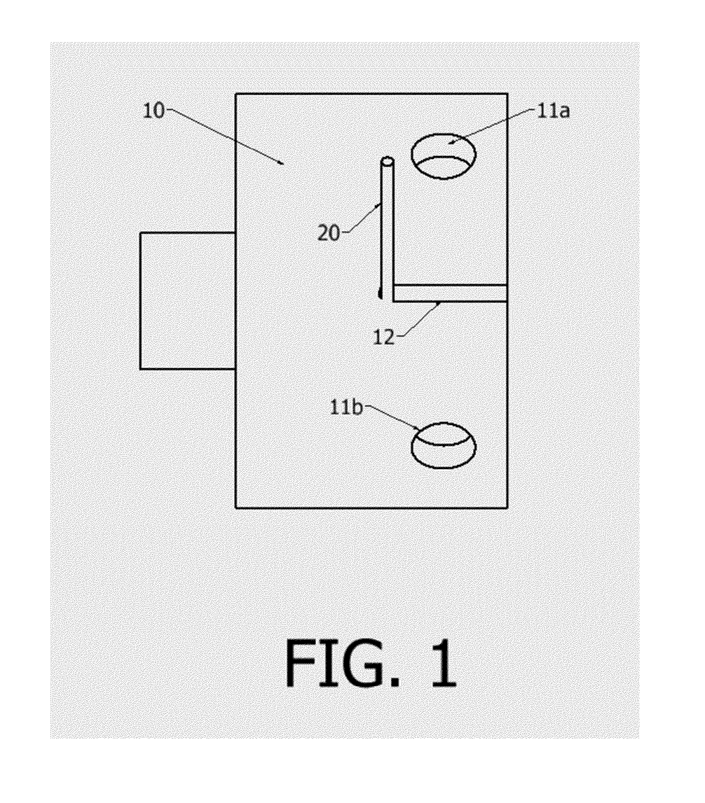

Referring to FIG. 1, filament enclosure 10 is rotationally locked to the shaft of the vegetation trimmer. Cutting filament 20 is stored inside filament enclosure 10 and extends through portal 12 in filament enclosure 10. Filament enclosure 10 rotates at a high rate to allow cutting filament 20 to cut vegetation. Portals 11a and 11b on filament enclosure 10 allow air circulation inside filament enclosure 10 while filament enclosure 10 is rotating.

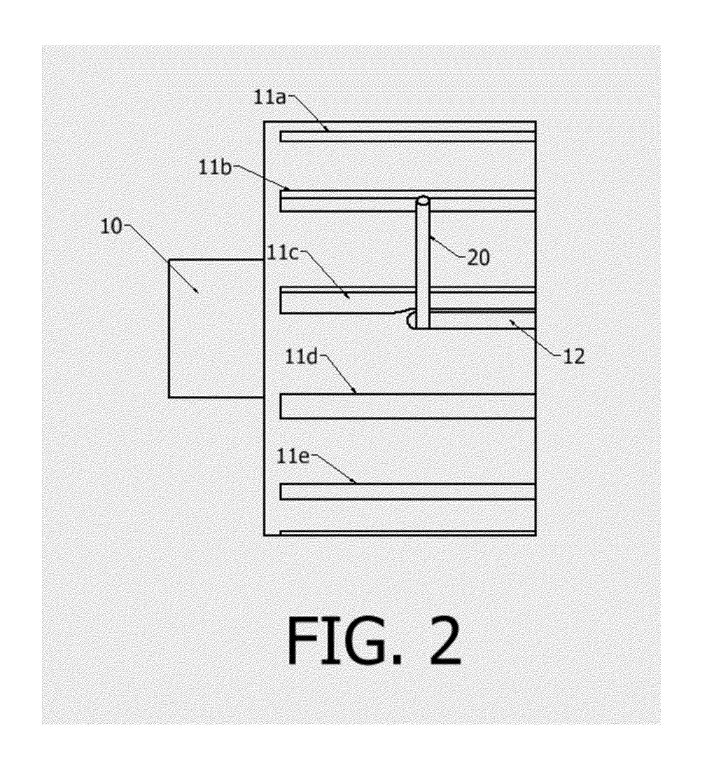

Referring now to FIG. 2, filament enclosure 10 is rotationally locked to the shaft of the vegetation trimmer. Cutting filament 20 is stored inside filament enclosure 10 and extends through portal 12 in filament enclosure 10. Filament enclosure 10 rotates at a high rate to allow cutting filament 20 to cut vegetation. Fins 11a-e on filament enclosure 10 direct air inside filament enclosure 10 while filament enclosure 10 is rotating.

I claim:

1. A vegetation trimmer, comprising:
a filament enclosure having at least one portal that comprise at least 10% of the surface area of the outside of the filament enclosure.

2. The vegetation trimmer of claim 1, wherein:
said portal runs the full axial length of said filament enclosure.

3. The vegetation trimmer of claim 1, wherein:
said portal is angled towards the direction of rotation of said filament enclosure.

4. A vegetation trimmer comprising:
a filament enclosure having at least one fin extending radially outward from said filament enclosure.

5. The vegetation trimmer of claim 4, wherein:
said fin runs the full axial length of said filament enclosure.

6. The vegetation trimmer of claim 4, wherein:
said fin is angled towards the direction of rotation of said filament enclosure.

7. A method of cooling the inside of a filament enclosure comprising:
rotating said filament enclosure at a high rate;
directing air flow through at least one portal that comprise at least 10% of the surface area of the outside of said filament enclosure.

8. The method of claim 7, comprising:
directing said air flow through at least one fin that extends radially outward from said filament enclosure.
